(19) United States
(12) Patent Application Publication
(10) Pub. No.: US 2021/0253289 A1
(43) Pub. Date: Aug. 19, 2021

(54) MEASUREMENT CONTROL DEVICE, PACKAGING DEVICE AND MEASUREMENT CONTROL METHOD

(71) Applicant: OMRON Corporation, KYOTO (JP)

(72) Inventor: Yuki HIROHASHI, Kyoto-shi, KYOTO (JP)

(73) Assignee: OMRON Corporation, KYOTO (JP)

(21) Appl. No.: 17/270,447

(22) PCT Filed: Mar. 6, 2019
(86) PCT No.: PCT/JP2019/008827

§ 371 Date: Feb. 23, 2021

(30) Foreign Application Priority Data
Jan. 10, 2019 (JP) 2019-002770

(51) Int. Cl. B65B 57/14; B65B 35/24

(52) U.S. Cl. CPC B65B 57/14; B65B 25/02; B65B 35/24

(57) ABSTRACT

The present invention is to provide a measurement control device that makes it possible to: perform optimal film packaging; and perform film packaging that is visually appealing without wasting film. According to the present invention, a sensor unit 1 is arranged in a horizontal direction and a vertical direction that are orthogonal to the direction in which articles to be packaged G are conveyed are connected to a measurement control device body 2. To the side of the measurement control device body 2 are furnished a distance calculation unit that calculates the distances to the articles to be packaged G based on information from the sensor unit 1, a width/height calculation unit that calculates the width and height of the articles to be packaged G from the distances, and a shape computation unit that computes the shapes of the articles to be packaged G additionally including the length.

### TECHNICAL FIELD

The present disclosure relates to a measurement control device used for controlling a packaging device or the like, a packaging device equipped with the measurement control device, and a measurement control method.

### BACKGROUND ART

In a conventional horizontal pillow type packaging device, a “film feed amount”, an “operation of a seal part (an operation timing and an operation speed)”, and an “operation of a supply conveyor” are set according to an article to be packaged based on data registered in advance as product information before an operation thereof or by creating the data.

Therefore, when the operation starts by performing setting according to a certain article to be packaged and then it is intended to package another article to be packaged having a different size, it is necessary to temporarily stop the packaging device and to reset the settings each time according to a size of each of the other articles to be packaged.

In this way, when the settings are changed every time the article to be packaged is changed, it takes a lot of time each time, and waste of a film occurs due to an adjustment of the film when the settings area changed.

In order to avoid frequent re-settings as described above, a setting may be made according to the largest one among the articles to be packaged, and a small article to be packaged may also be packaged with a film having the same size. In this case, along with a large amount of waste in the film, the small article to be packaged is present in a large film, and thus a problem that an “appearance” of the packaging is deteriorated is caused.

An invention described in Patent Literature 1 below (FIG. 7) has been proposed as a solution to the above-described problem. According to this invention, it is not necessary to perform re-setting each time the size of the article to be packaged becomes different, and film is not wasted. Moreover, it is possible to provide a pillow type packaging device capable of quickly performing packaging with a good appearance.

The pillow type packaging device described in Patent Literature 1 is a pillow type packaging device including a packaging device main body 50, and a supply conveyor C which is disposed upstream of the packaging device main body 50 and supplies an article G to be packaged to the packaging device main body 50. The pillow type packaging device includes an article detection sensor 60 which detects a length of the article G to be packaged, and a control device 70 which calculates an operation pattern of a sealing means of a top seal part, an operation timing, and a length of a film required for packaging based on the length of the article G to be packaged calculated based on data detected by the article detection sensor 60, and controls an operation of the sealing unit based on the calculated results thereof.

According to the pillow type packaging device described in Patent Literature 1, even when articles G to be packaged having different lengths are continuously supplied to the packaging device main body 50, data regarding the length of the article G to be packaged can be detected for each of the articles G to be packaged by the article detection sensor 60, and control can be performed such that top sealing is performed with the operation pattern and operation timings of the sealing unit of the top seal part suitable for the article G to be packaged based on the length of the film required for packaging calculated based on the detected data.

Therefore, even when articles G to be packaged having different lengths continuously enter, or even when articles G to be packaged having the same long or short length continuously enter, film packaging with an optimum length for all articles G to be packaged can be optimally performed.

Thus, it is not necessary to perform setting for each of the different articles G to be packaged, film is not wasted, and film packaging with a good appearance can be performed.

### Technical Problem

However, in the pillow type packaging device described in Patent Literature 1, the article detection sensor 60 is disposed in the horizontal direction to detect the length of the article G to be packaged. Therefore, for example, when an article G to be packaged having a shape shown in FIG. 8 enters, some of a light beam of the article detection sensor 60 passes under the article G to be packaged, and the length of the article G to be packaged cannot be accurately detected. Moreover, a height of the article G to be packaged cannot be accurately detected. In other words, there remains a problem that a size and a shape of the article G to be packaged cannot be accurately detected.

Therefore, there is a possibility that a problem as shown in FIG. 9 may occur.

That is, in the case of packaging crops of the same variety or bread of the same type, such as agricultural products and bread, which have different sizes and shapes for each of articles to be packaged, even in the pillow type packaging device described in Patent Literature 1, there remains a problem that it is difficult to optimally perform optimal film packaging.

### CITATION LIST

### Patent Literature

Patent Literature 1

Japanese Patent No. 5325179

### SUMMARY OF INVENTION

### Solution to Problem and Effect

The present disclosure has been made in view of the above-described problems, and provides a measurement control device, a packaging device equipped with the measurement control device, and a measurement control method capable of optimally performing optimum film packaging without wasting film and capable of performing film packaging with a good appearance, even in a case in which articles to be packaged that have different sizes and shapes, such as agricultural products and bread, are packaged.

In order to achieve the above-described object, a measurement control device (1) according to the present disclosure is a measurement control device used for controlling a packaging device, in which

a sensor unit in which a detection axis of a sensor is disposed in a horizontal direction and a vertical direction orthogonal to a traveling direction in which an article to be packaged is conveyed is connected to a measurement control device main body, the measurement control device including:
a width/height calculation unit provided on a side of the measurement control device main body to calculate a distance between the sensor unit and the article to be packaged based on information from the sensor unit and to calculate a width and a height of the article to be packaged from the distance, and
a shape calculation unit configured to calculate a shape of the article to be packaged including a length thereof.

According to the measurement control device (1), since the detection axis of the sensor is disposed in the horizontal direction and the vertical direction, regardless of the shape of the article to be packaged, the size and the shape of the article to be packaged including a width, a height, and a length (including a contour length) can be accurately calculated. Thus, even in the case in which articles to be packaged having different sizes and shapes, such as agricultural products and bread, are packaged, it is possible to optically perform optimal film packaging, and film packaging with a good appearance can be performed without wasting the film.

Further, in the measurement control device (1), a measurement control device (2) according to the present disclosure may further include:
a control command creation unit configured to create a control command based on a control program, and
a drive control unit configured to control a drive unit such as a motor based on the control command.

According to the measurement control device (2), it is possible to realize accurate control based on accurate measurement, and thus even in the case in which articles to be packaged having different sizes and shapes, such as agricultural products and bread, are packaged, it is possible to optically perform optimal film packaging, and film packaging with a good appearance can be performed without wasting the film.

Also, in a measurement control device (3) according to the present disclosure, in any one of the measurement control devices (1) or (2), the sensor unit may be configured by selecting one or more of an optical sensor, an ultrasonic sensor, a mechanical sensor, and an image pickup sensor.

According to the measurement control device (3), it is possible to select an optimal sensor according to a type of the article to be packaged and a mounting situation, and it is possible to promote accurate detection of the article to be packaged.

Also, a packaging device according to the present disclosure is a packaging device equipped with the measurement control device described in any one of the measurement control devices (1) to (3).

According to the packaging device (1), since the detection axis of the sensor is disposed in the horizontal direction and the vertical direction, regardless of the shape of the article to be packaged, the size and the shape of the article to be packaged including the width, the height, and the length can be accurately calculated. Thus, even in the case in which articles having different sizes and shapes, such as agricultural products and bread, are packaged, it is possible to optically perform optimal film packaging, and film packaging with a good appearance can be performed without wasting the film.

Further, a measurement control method (1) according to the present disclosure is a measurement control method in the measurement control device described in any one of the measurement control devices (1) to (3), the method including:
a signal acquisition step of acquiring an information signal from the sensor unit;
a distance conversion step of converting the information signal acquired in the signal acquisition step into a distance,
a width/height calculation step of calculating the width and the height of the article to be packaged from distance information converted in the distance conversion step, and
an overall shape calculation step of further calculating the length, the width and the height of the article to be packaged, that is, an overall shape of the article to be packaged from the width and the height information of the article to be packaged obtained in the width/height calculation step.

According to the measurement control method (1), regardless of the shape of the article to be packaged, the size and shape of the article to be packaged including the width, the height, and the length can be accurately calculated. Thus, even in the case in which articles to be packaged having different sizes and shapes, such as agricultural products and bread, are packaged, it is possible to optically perform optimal film packaging, and film packaging with a good appearance can be performed without wasting the film.

Further, in the measurement control method (1), a measurement control method (2) according to the present disclosure may further include:
a control amount calculation step of calculating a control amount for a drive unit based on overall shape information of the article to be packaged obtained in the overall shape calculation step,
a control command creation step of creating a control command based on a calculation result obtained in the control amount calculation step, and
an output process step of performing an output process of the control command created in the control command creation step.

According to the measurement control method (2), it is possible to realize accurate control based on accurate measurement, and thus even in the case in which articles to be packaged having different sizes and shapes, such as agricultural products and bread, are packaged, it is possible to optically perform optimal film packaging, and film packaging with a good appearance can be performed without wasting the film.

### BRIEF DESCRIPTION OF DRAWINGS

FIG. 1 is a perspective view schematically showing an arrangement of a measurement control device according to an embodiment.

FIG. 2 is a schematic side view showing an example in which a measurement control device according to the embodiment is applied to a packaging device.

FIG. 3 is a functional block diagram showing a configuration of the measurement control device according to the embodiment.

FIG. 4 is a flowchart showing an example of a process operation of the measurement control device according to the embodiment.

FIG. 5 is a graph showing a case in which a length of an article to be packaged is calculated and obtained.

FIG. 6 is a side view showing a state in which the article to be packaged is sensed by the measurement control device.

FIG. 7 is a side view showing a configuration example of a conventional packaging device.

FIG. 8 is a side view showing a situation in which an article to be packaged is sensed using a conventional measurement control device.

FIG. 9 is a side view showing a state which can occur as a result of sensing an article to be packaged using the conventional measurement control device.

### DESCRIPTION OF EMBODIMENTS

Hereinafter, embodiments of a measurement control device and a packaging device equipped with the measurement control device according to the present disclosure will be described with reference to the drawings.

### [Configuration Example of Sensor Unit]

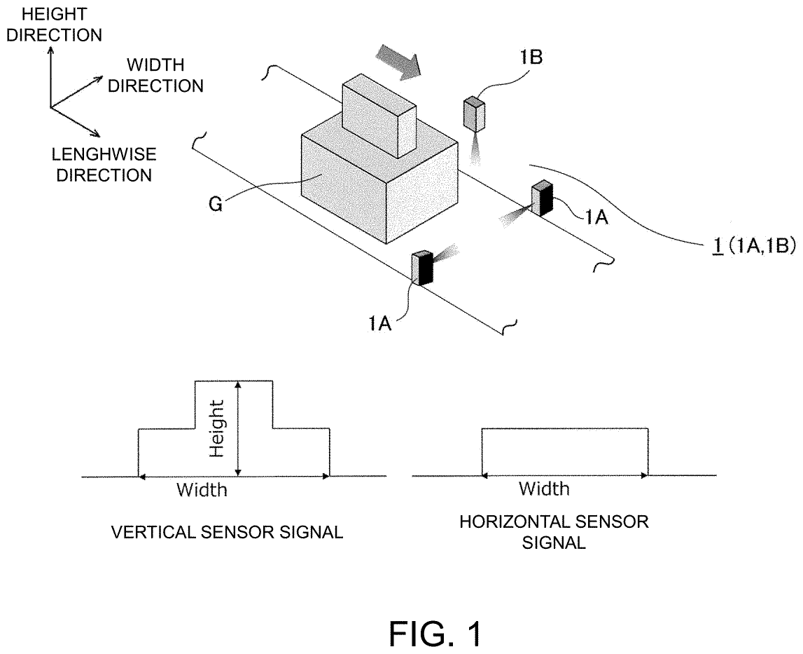

FIG. 1 is a schematic perspective view showing an arrangement example of a sensor unit of a measurement control device according to an embodiment.

Two sensors 1A and 1A are disposed in a horizontal direction orthogonal to a traveling direction in which an article G to be packaged is conveyed, one sensor (1B) is disposed in a vertical direction, and a sensor unit 1 is configured of the sensors 1A and 1A and the sensor 1B.

An optical type sensor or another type, for example, an ultrasonic sensor type or a mechanical type (a limit switch type) can be adopted as the sensors constituting the sensor unit 1. Further, in addition to an optical sensor, an image pickup device type sensor which can recognize an image can be used as the optical type sensor.

With such an arrangement, a width of the article G to be packaged can be accurately detected by the two sensors 1A and 1A disposed in the horizontal direction. Further, a height of the article G to be packaged can be accurately detected by the sensor 1B disposed in the vertical direction. When a calculation described later is performed based on the detected data, the width, the height, and the length of the article G to be packaged, in other words, an overall shape of the article G to be packaged can be accurately obtained by the calculation.

### [Application Example of Measurement Control Device]

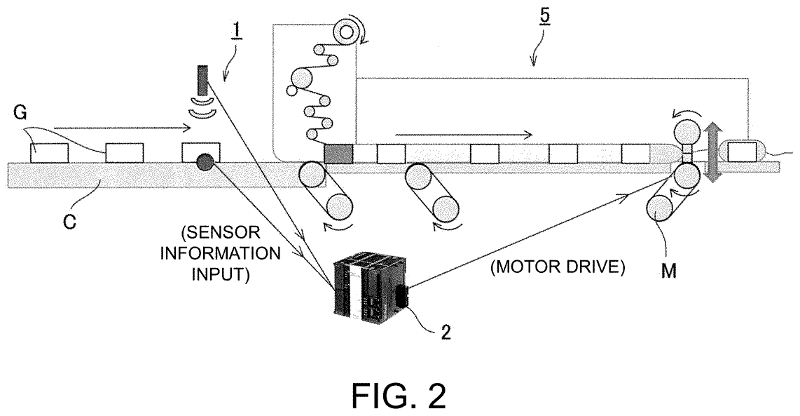

FIG. 2 is a schematic side view showing a packaging device equipped with a measurement control device according to the embodiment, and the sensor unit 1 is disposed on the upstream side of a packaging device main body 5.

A measurement control device main body 2 receives a detection signal from the sensor unit 1, calculates the shape of the article G to be packaged, determines a control amount (a film length, a cut position, and the like) from the calculation results thereof, and drives a motor M on the packaging device main body 5 side based on the control amount thereof.

### [System Configuration Example]

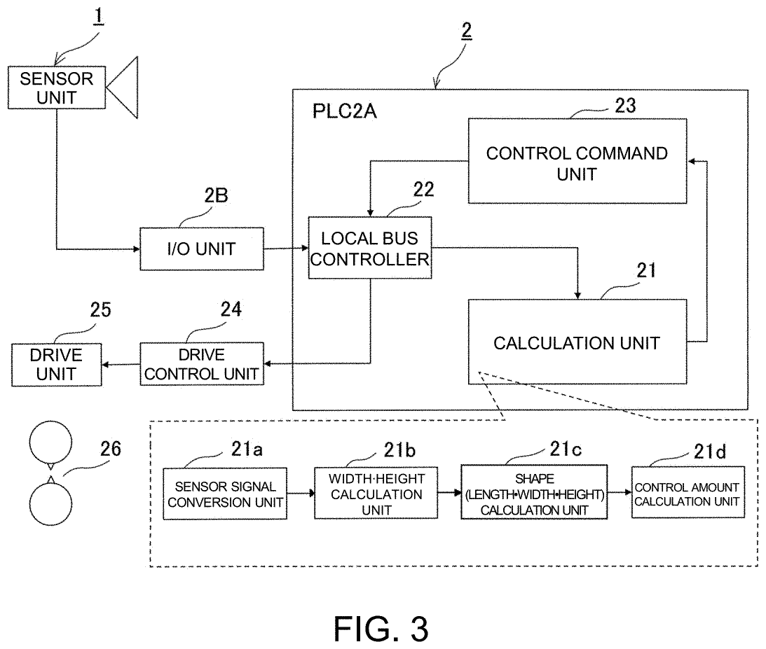

FIG. 3 is a functional block diagram showing a system configuration of the measurement control device according to the embodiment, and the sensor unit 1 is connected to a programmable logic controller (PLC) 2A via an I/O unit 2B. The PLC 2A is configured of one or more computers including a central processing unit (CPU), a random access memory (RAM), and a read only memory (ROM), and is configured to include a calculation unit 21, a local bus controller 22, and a control command unit 23 as functional blocks.

The calculation unit 21 performs various calculations, but in the case of the present embodiment, the calculation unit 21 is further divided into functional blocks, and is configured to include:
a sensor signal conversion unit 21a which processes a signal from the sensor unit 1 so that a calculation of the calculation unit 21 is enabled,
a width/height calculation unit 21b which calculates a width and a height of the article G to be packaged from the sensor signal,
a length/width/height calculation unit 21c which further calculates a length, the width and the height of the article G to be packaged from the sensor signal, and
a control amount calculation unit 21d which calculates a film length, a cut position, a control amount of a drive unit 25, and the like from the obtained length, width and height of the article G to be packaged.

The I/O unit 2B to which the sensor unit 1 is connected is connected to the local bus controller 22, and the local bus controller 22 is connected to the calculation unit 21. The local bus controller 22 controls a bus line which connects each of the functional blocks inside the PLC 2A, and controls the bus line so that functions of the PLC 2A are fully exhibited.

The calculation unit 21 is connected to the control command unit 23, and the control command unit 23 is connected to the local bus controller 22. The calculation unit 21 has a function of performing almost all of various calculation processes inside the PLC 2A, and performs many calculation processes including the above-described calculation processes.

The local bus controller 22 is also connected to a drive control unit 24 outside the PLC 2A, and the drive control unit 24 is connected to the drive unit 25. The drive unit 25 is configured to drive a cutter 28 and the like.

### [Process Operation Example]

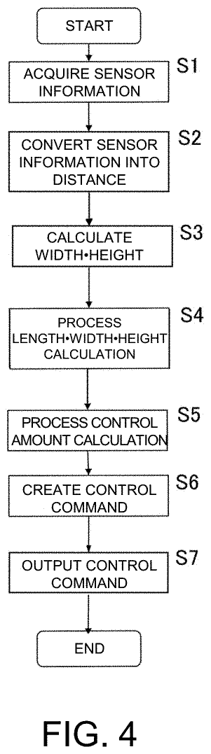

FIG. 4 is a flowchart showing an example of a process operation in the calculation unit 21 of the measurement control device according to the embodiment.

First, In Step S1, acquisition of an information signal from the sensor unit 1 start.

When the acquisition of the information signal from the sensor unit 1 is completed in Step S1, the process proceeds to Step S2, and in Step S2, the information signal from the sensor unit 1 is converted into a distance.

When the information signal from the sensor unit 1 is converted into a distance in Step S2, the process proceeds to Step S3, and the width and the height of the article G to be packaged are calculated from the distance information converted in Step S2.

Next, the process proceeds to step S4, and the width, the height and the length (including a contour length), that is, an overall shape and profile of the article G to be packaged are calculated from the width and height information of the article G to be packaged obtained in Step S3.

Next, the process proceeds to step S5, and a process of calculating a control amount (a film length, a determination of a cut position, a drive amount of the drive unit 25, and the like) with respect to the drive unit 25 is performed based on the overall shape and profile information of the article G to be packaged obtained in Step S4.

Next, the process proceeds to step S6, a control command is created based on the calculation results obtained in Step S5, then the process proceeds to Step S7, an output process of the control command is performed in Step S7, and then the process operation is terminated.

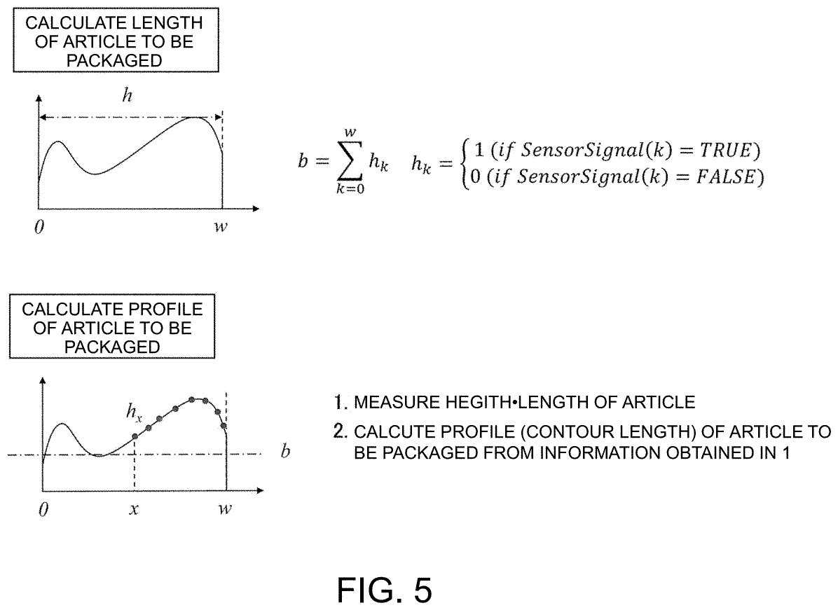

FIG. 5 is a graph showing a process of obtaining the contour length of the article G to be packaged by a calculation. First, the length of the article G to be packaged is obtained by a determination of whether or not a signal of the sensor can be detected. Additionally, the height of each of plot points is also obtained. The contour length of the article G to be packaged can be obtained by integrating the obtained height and length information. At the same time, since the width information at each of the plot points is also obtained, the overall shape (profile) of the article G to be packaged is obtained.

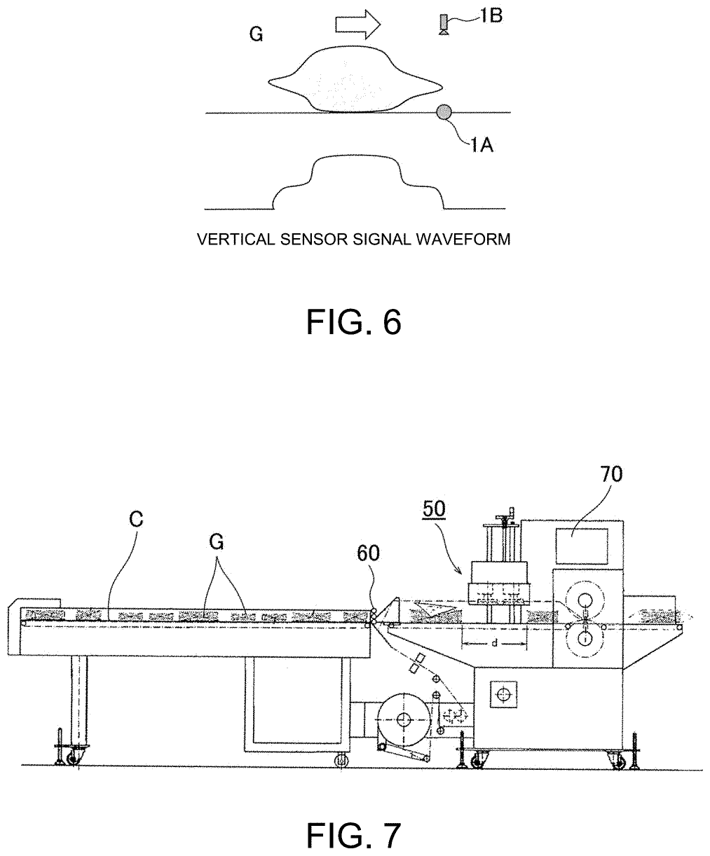

FIG. 6 is a side view showing a state in which the article G to be packaged shaped like a croissant is sensed by the measurement control device according to the present embodiment.

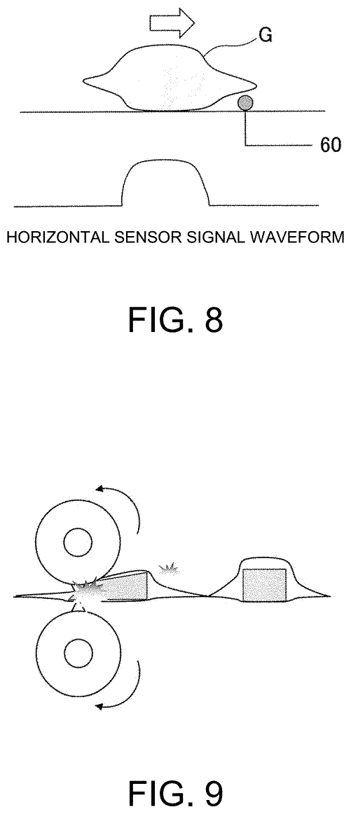

When the article G to be packaged having the shape shown in the drawing is sensed, it is impossible to obtain an accurate length of the article G to be packaged with the conventional one (refer to FIG. 8), but it is shown that the length, the width, the height, and the contour length (the overall profile) of the article G to be packaged can be accurately obtained using the measurement control device according to the present embodiment.

According to the measurement control device according to the above-described embodiment, since the sensor unit is disposed in the horizontal direction and the vertical direction, it is possible to accurately calculate the size and shape of the article to be packaged including the width, the height, and the length (including the contour length). Thus, even in the case in which articles to be packaged having different sizes and shapes, such as agricultural products and bread, are packaged, it is possible to optically perform optimal film packaging, and film packaging with a good appearance can be performed without wasting the film.

### [Modification Example]

Although the embodiments of the present disclosure have been described above in detail, the above description is merely an example of the present disclosure in all respects. Needless to say, various improvements and changes can be made without departing from the scope of the present disclosure.

For example, in the above-described embodiment, the number of sensors 1B disposed in the vertical direction is one, but in another embodiment, a plurality of sensors 1B may be disposed, and detection accuracy due to the sensor 1B can be further improved by disposing the plurality of sensors 1B.

### INDUSTRIAL APPLICABILITY

The present disclosure can be widely used in industrial fields such as packaging lines for film packaging of an article to be packaged, or a packaging system including the packaging lines.

### REFERENCE SIGNS LIST

1 Sensor unit

1A Sensor (horizontal direction)

1B Sensor (vertical direction)

2 Measurement control device main body

2A PLC

2B I/O unit

21 Calculation unit

21a Sensor signal conversion unit

21b Width/height calculation unit

21c Length/width/height/calculation unit

21d Control amount calculation unit

22 Local bus controller

23 Control command unit

24 Drive control unit

25 Drive unit

26 Cutter

M Motor

5 Packaging device main body

50 Packaging device main body

60 Article detection sensor

70 Control device

C Supply conveyance

G Article to be packaged

1. A measurement control device used for controlling a packaging device, in which a sensor unit in which a detection axis of a sensor is disposed in a horizontal direction and a vertical direction orthogonal to a traveling direction in which an article to be packaged is conveyed is connected to a measurement control device main body, the measurement control device comprising:
a width/height calculation unit provided on a side of the measurement control device main body to calculate a distance between the sensor unit and the article to be packaged based on information from the sensor unit and to calculate a width and a height of the article to be packaged from the distance; and
a shape calculation unit configured to calculate a shape of the article to be packaged comprising a length thereof.

2. The measurement control device according to claim 1, further comprising:
a control command creation unit configured to create a control command based on a control program; and
a drive control unit configured to control a drive unit such as a motor based on the control command.

3. The measurement control device according to claim 1, wherein the sensor unit is configured by selecting one or more of an optical sensor, an ultrasonic sensor, a mechanical sensor, and an image pickup sensor.

4. A packaging device which is equipped with the measurement control device according to claim 1.

5. A measurement control method in the measurement control device according to claim 1, the method comprising:
a signal acquisition step of acquiring information signal from the sensor unit;
a distance conversion step of converting the information signal acquired in the signal acquisition step into a distance;
a width/height calculation step of calculating the width and the height of the article to be packaged from distance information converted in the distance conversion step; and
an overall shape calculation step of further calculating the length, the width and the height of the article to be packaged, that is, an overall shape of the article to be packaged from the width and the height information of the article to be packaged obtained in the width/height calculation step.

6. The measurement control method according to claim 5, further comprising:
a control amount calculation step of calculating a control amount for a drive unit based on overall shape information of the article to be packaged obtained in the overall shape calculation step;
a control command creation step of creating a control command based on a calculation result obtained in the control amount calculation step; and
an output process step of performing an output process of the control command created in the control command creation step.
